(19) United States
(12) Patent Application Publication
(10) Pub. No.: US 2016/0012705 A1
(43) Pub. Date: Jan. 14, 2016

(54) METHOD AND DEVICE FOR COLORIMETRIC MEASURING AND DISPLAY OF PHYSICOCHEMICAL DATA

(71) Applicant: BLEU ELECTRIQUE, Marseille (FR)

(72) Inventor: Emmanuel BARET, Marseille (FR)

(21) Appl. No.: 14/790,218

(22) Filed: Jul. 2, 2015

(30) Foreign Application Priority Data
Jul. 10, 2014 (FR) 14/56652

(51) Int. Cl. G08B 21/18; G08B 5/36; G01N 27/416

(52) U.S. Cl. CPC G08B 21/18; G01N 27/416; G08B 5/36

(57) ABSTRACT

A device for colorimetric measuring and signaling of one or several physicochemical values of a liquid medium is disclosed. This device includes: at least one sensor capable of measuring at least one physicochemical parameter of the medium; at least one light indicator designed for emitting a colored light with variable color depending on an electrical control signal; and an electronic control circuit connected to a sensor and configured to convert at least one measurement of the sensor into an electrical input signal of the indicator to cause the emission of a light with a color depending on the measurement of the physicochemical parameter.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention concerns a method for colorimetric measuring and display of physicochemical data in a liquid medium, and in particular of water. It also concerns a device for the implementation of this method.

More specifically, the present invention concerns a method and a device for colorimetric measuring and indication of physicochemical values of water for the monitoring and maintenance of water in swimming-pools.

2. Description of Related Art Including Information Disclosed under 37 CFR 1.97 and 37 CFR 1.98

In order to maintain cleanliness and clearness of swimming-pool water and to ensure its sanitary condition, it is indispensable to apply various treatments to it. These treatments make it necessary to measure several physicochemical parameters relevant for defining the condition of the water, such as temperature, the pH-value, the oxidation-reduction or redox potential (ORP), conductivity, salinity or the amount of dissolved solids, . . . . Most often these treatments consist of incorporating chemical products capable of counteracting the causes of water alteration so as to make it clean and limpid. However, this implies close verification of water conditions with respect to the various physicochemical parameters to consider. Then again, this simple method has the disadvantage of creating an odor or to make the water a skin or eye irritant, particularly when too high dosages of treatment products are added to the water.

At present, there is a great number of analytic equipment providing numerical display of the physicochemical parameters of the water by digitally indicating the measuring results of these parameters. These displays of the results are generally very precise, but reading and interpreting these results is difficult and tedious for the users, especially private pool owners.

One aim of the present invention is to remedy this inconvenience by offering a device capable of replacing the numerical display by a colorimetric display of the measured values.

### BRIEF SUMMARY OF THE INVENTION

According to the invention, this aim has been achieved thanks to a measuring device with colorimetric indication of one or several physicochemical values of a liquid medium, in particular for monitoring and maintenance of swimming-pool water. The device includes:
at least one sensor for measuring at least one physicochemical parameter of the medium;
at least one luminous indicator designed to emit a colored light with variable color, depending on an electrical control signal;
an electronic control circuit linked to the electrochemical sensor and configured to convert the size of the value measured by the sensor into an electrical control signal of the luminous indicator to trigger the emission of a light with a color corresponding to the measure of said physicochemical parameter.

What is meant by colorimetric measure is a measure in the form of a colored indication. The colored indication may be in various forms such as the emission of a colored light or the illumination of a medium with a colored light. In particular, the illuminated medium may be the water of which one wants to know the sanitary condition or the physicochemical values. The colored indication may also feature the display of one or more colored measurement ranges.

Variable color means a color the tint or hue of which varies depending on the control signal and thus also the measurement. The color supplied by the indicator may come from one or several sources of white light, augmented, for example, with colored filters and optical switches with liquid crystals.

Preferably however, the color can also be modified, as described below, by the synthesis of colors of several light sources or by the changing utilization of these sources.

The sensor is preferably an electrochemical sensor reacting to a physicochemical parameter of the liquid medium to be analyzed or to the variation of a physicochemical parameter. Although the invention can be adapted to the control of different types of liquid media, a specific application is envisaged, as previously indicated, for monitoring water, and especially swimming-pool water. In the following description, reference will therefore essentially to water. Thus, the sensor includes, for example, electrodes or a probe for measuring parameters such as the pH-factor, a value of redox potential, conductivity, salinity, a percentage of dissolved solids, turbidity, or water temperature. The sensor may specifically feature a sensor for measuring the intensity of an electric current of electrolysis such as an ammeter.

Thus, and always as examples, the color of the luminous indicator may vary proportionally or at least in accordance with one of the aforementioned parameters. As becomes clear in the following description, the color may also vary depending on a plurality of parameters.

The electrochemical sensor emits a measuring signal reflecting the size of the measured value. This may be, for example, a measuring voltage or current. This is supplied to the control circuit which converts it into one or several control signals of the luminous indicator.

According to one implementation of the invention, the indicator may feature a plurality of monochrome light sources, each capable of emitting light of a specific color and variable intensity. The monochrome light sources can be designed so as to produce said variable color of the light indicator by synthesis of their respective colors.

Monochrome light sources are those which emit light of a given specific color. This does not prejudge the width of their emission spectrum which, however, represents only a portion of the sufficiently limited visible spectrum so as to appear colored.

Preferably, the individual light sources may be selected to emit in complementary colors, so as to extend the pallet of colors capable of being rendered by the resulting luminous indication. For example, the colors may be red, green, and blue. This allows the advantageous use of light-emitting diodes (LEDs), easily available in these colors, as monochrome individual light sources. As indicated above, the individual light sources, for example the LEDs may be designed so that a light synthesis is achieved. Thus, the diodes are, for example, designed to illuminate a common reading range, to illuminate a common zone of a medium, or so that their light shares a common optical path.

Instead of several LEDs of different colors, the indicator may also feature one or several multicolor LEDs.

The multicolor LEDs with multiple controls can in effect directly emit a colored light of variable color. The light synthesis occurs in this case directly inside the housing of the LED.

Depending on the configuration of the light indicator, the control circuit can deliver one or several control signals, for example for current or for voltage. However, according to an implementation of the invention using a plurality of monochrome light sources, the control circuit can be designed to produce one or several signals at modulated pulse width respectively for each monochrome light source, so as to adjust the light intensity.

Thus the individual adjustment of intensity of each source allows controlling the contribution of the corresponding color in the resulting light emitted by the indicator.

The color of the light indicator can be modified as a function of a single parameter and thus indicate a value of this parameter. It can also be modified as a function of several parameters and indicate an overall condition of the quality or the sanitary condition of the water.

Thus, according to an implementation of the invention, the device may feature a plurality of sensors capable of measuring respectively, distinct physicochemical parameters of the liquid medium or the water to be analyzed. The control circuit is connected, respectively, to each sensor and designed to produce a distinct control signal respectively for each of the monochrome light sources of the indicator, in response respectively to the measurement of a distinct sensor, so that the light intensity emitted by each monochrome source depends respectively on the measurement of a sensor.

When several values are measured, a distinct primary color may be attributed to each of the physicochemical values so that the resulting color gives an instantaneous and intuitive indication of the size of the corresponding values.

The components of the measuring and display system, in particular the sensor or sensors and the light indicator may be housed in a watertight container. This container includes, for example, a hollow body delimiting a measuring chamber and a cover. It may be provided with an inlet and an outlet opening to allow circulation of the liquid medium, and in particular of water inside said housing. In other respects, at least one element or one portion of this housing may be made of a transparent or translucent material.

The housing may also be provided with an inlet opening (5) and an outlet opening (6) which are intended for branching of the device on an outflow pipe (C) of a swimming pool, so that, when the housing (4) is installed on the pipe, the sensor or sensors are immersed in a current of water flowing through the housing.

The invention also concerns a method for colorimetric measuring and display of physicochemical values in a liquid medium and in particular in water. According to this method, in the water to be analyzed for its healthiness or sanitary condition, at least one sensor is immersed for at least one physicochemical parameter, in particular a parameter contributing to the limpidity of the analyzed water and/or to its good sanitary condition; at least one measurement signal of the sensor is supplied to a control circuit of a luminous indicator capable of emitting a light of variable color; and an electrical control signal is supplied from the control circuit to the indicator so as to cause the emission of a light the color of which depends on the measurement of the sensor or sensors.

The sensor may specifically be an electrochemical sensor capable of measuring the previously mentioned parameters.

According to an implementation of the method one may use a light indicator with a plurality of complementary monochrome light sources, each capable of emitting a light with a specific color, with variable intensity, the monochrome light sources being designed to produce said variable color by synthesis of the colors.

Incidentally, and still according to a particular implementation of the method, one may use the light emitted by the light indicator to illuminate the medium the healthiness or sanitary condition of which is to be analyzed. According to this implementation, the water or analyzed medium becomes itself the display of its own characteristics.

The method and the device according to the invention offer several interesting advantages, particularly for the control of swimming-pool water. They are, in these circumstances:
rapid and simple readout of the physicochemical parameters which limpid water of good sanitary quality must meet;
instantaneous and simultaneous control of several physicochemical parameters of the analyzed water.

### BRIEF DESCRIPTION OF THE SEVERAL VIEWS OF THE DRAWINGS

The aforementioned aims, characteristics, and advantages and still others, will become clearer in the following detailed description and the attached drawings in which:

FIG. 1 is a schematic view illustrating the device of the invention for measuring and displaying a single physicochemical value.

FIG. 2 is a schematic view illustrating the device of the invention for measuring and displaying several physicochemical values, and more precisely, three physicochemical values of water to be analyzed.

FIG. 3 is a schematic view illustrating an implementation of the device of the invention where the electrochemical sensors are constituted by the electrodes of an electrolyzer outfit.

FIG. 4 is a schematic view illustrating the device of the invention for measurement and display of the pH-factor.

FIG. 5 represents the display schema of the pH-factor as based on three LEDs, red, green, and blue.

Reference is made to these drawings to describe interesting, although by no means limiting, examples of production of the device for colorimetric measurement and display and of implementation of the method according to the invention.

### DETAILED DESCRIPTION OF THE INVENTION

According to this method, one immerses in the water W to be analyzed at least one electrochemical sensor 1 designed to be sensitive to at least one of the physicochemical parameters necessary for the maintenance of the qualities the water must have for certain ones of its intended purposes or of the variations of this parameter.

More specifically, in the application for the maintenance of clarity and hygienic qualities of the water in swimming-pools this water is defined by a plurality of physicochemical parameters such as:
temperature;
pH;
redox potential (ORP);
salinity or percentage of dissolved solids;
conductivity of the water.

This electrochemical sensor 1 is electrically connected to a light indicator 2 designed to emit a colored light which varies depending on the size of the value measured by said sensor (FIG. 1).

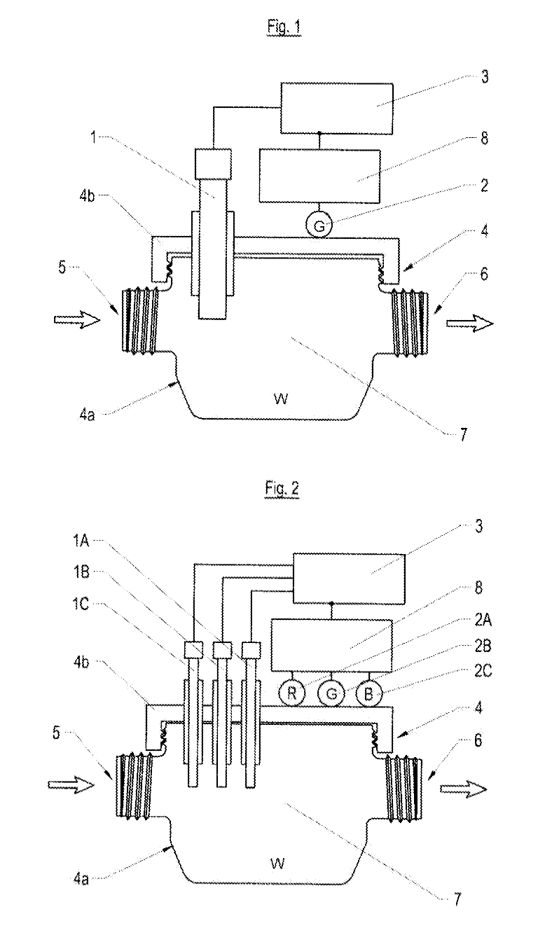

Preferably, one immerses (FIG. 2) in the water W to be analyzed a plurality of electrochemical sensors 1A, 1B, 1C, . . . each designed to sense one of the specific physicochemical parameters to be taken into consideration for the definition of healthy water. Each of these electrochemical sensors 1A, 1B, 1C, . . . is dedicated to the measurement of the condition of one of the physicochemical parameters of the water.

Each electrochemical sensor 1A, 1B, 1C, . . . is electrically connected to at least one colored light source 2A, 2B, 2C emitting a light in a color that is specific to it, so that the intensity of colored light of each light source varies depending on the size of physicochemical value measured (detected) by the electrochemical sensor associated to it.

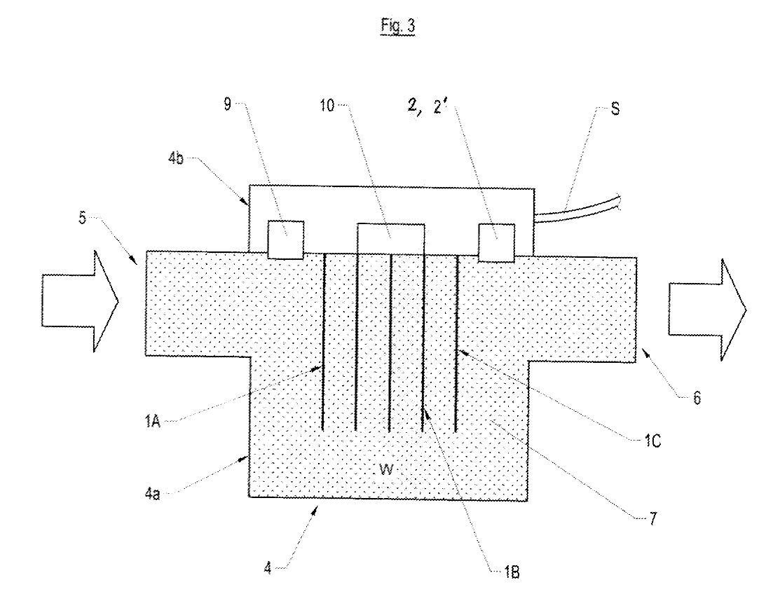

According to another implementation of the method of the invention, the totality of the electrochemical sensors 1A, 1B, 1C, . . . is connected to one multicolored light source 2′ (FIG. 3).

According to the method of the invention, one attributes a light source 2A,2B, 2C, of a particular color respectively to a physicochemical value measured by an electrochemical sensor 1A, 1B, 1C, . . . such as temperature, pH, redox potential (ORP), . . . so that the light intensity of said light source varies respectively depending on the size of the measured physicochemical value.

According to an advantageous example of implementation of the method of the invention in which several values are measured, complementary colors, for example primary colors are attributed to each of the physicochemical values so that the resulting color gives an instantaneous and intuitive indication of the size of the corresponding values.

In its most simple version, the analysis and display device according to the invention includes more particularly:
at least one electrochemical sensor 1 designed to register at least one physicochemical parameter contributing to the clarity of the analyzed water and its good sanitary condition; this electrochemical sensor is electrically connected:
   on the one hand, to an electric power supply which may be the mains current or a battery, and of which only the power cord S is shown on FIG. 3, and
   on the other hand, to at least one source of colored light of the indicator 2 designed to emit a colored light;
the electronic control circuit connecting the electrochemical sensor to the colored light source 2.

The electrochemical sensor 1, the light indicator 2, and the electronic circuit 3 constitute, together, a measuring and display unit of the measured values.

The active elements of this measuring and display cell are housed in a watertight housing 4, this housing being, for example, constituted by a hollow body 4a and a cover or lid 4b, and provided with an inlet opening 5 and an outlet opening 6 to allow water to circulate inside said housing. At least one element or constitutive part of the housing is made of some transparent or translucent material so that the light emitted by the light source(s) is visible through the transparent portion of the housing.

The lid or cover 4b is, for example, fastened by screws to the body 4a of the housing 4. In the case of application to sanitation of swimming-pool water, the housing 4 is located in the service room, on the filtration circuit, downstream of the water outlet orifice 6 of the swimming-pool water on a return pipe C.

The housing 4 delimits, internally, a measuring chamber 7 traversed by the flow or current of water circulating in the pipe C and in which the electrochemical sensor(s) 1 is (are) immersed.

Preferably, several electrochemical sensors 1A, 1B, 1C, . . . are each designed to be sensitive to at least one specific physicochemical parameter of the water to be analyzed and associated to at least one colored light source emitting in a color that is different from that of the other light sources. Thus, the device includes a plurality of detection units comprising, each, an electrochemical sensor 1 and a colored light source 2 connected to the latter by means of a control circuit.

According to one version, the sensor(s) are linked to a multicolor light source 2′ designed to emit light in a predetermined color dedicated to the display of the measured value of one of the physicochemical parameters.

Preferably, the detection unit 1-2-3 or each detection unit 1-2-3 is inserted in an outlet pipe of the swimming-pool, by any suitable watertight means of connection, so as to allow circulation of the swimming-pool water.

Preferably and advantageously, the cover or lid 4b of the housing 4 is made of a transparent or translucent material so as to permit the readout of the colorimetric display resulting from the emission of the light source(s) 2A, 2B, 2C, . . . the body 4a of said housing being made of an opaque material.

The cover or lid 4b is fastened, for example by screws, on the threaded upper end of the body 4a of the housing 4.

The sensor(s) 1A, 1B, 1C, . . . , and the light source(s) 2A,2B, 2C, . . . are fastened on the lid 4b of the housing 4, so that, when the lid is closed, the sensor(s) is (are) immersed in the water flowing through the measuring chamber 7, inside said housing, and the light sources 2A, 2B, 2C, . . . emit in the direction of said chamber.

The detection and display device, and more precisely the electronic control circuit 3, also includes a control device 8 known as such or within the grasp of the expert. This control device is in this example an electronic circuit dedicated to piloting the LEDs. It allows controlling the intensity of the Red, Green, and Blue LEDs thereby composing the color tint to display according to the measurement information received. The control device 8 enables the production of a pulse width modulation signal for each primary color so as to adjust its light intensity.

According to another arrangement, the display device also includes a temperature sensor for detecting the temperature of the analyzed water.

Advantageously, for the readout of several physicochemical values, the device features several sensors 1A, 1B, 1C, . . . , to measure different physicochemical values, each of these sensors being connected to a light source, for example constituted by a LED with which it forms a colorimetric detection and display unit. The LED(s) 2; 2A, 2B, 2C, . . . , are designed to emit a light in one of the primary colors (green, red, blue) or in tints of these colors.

According to another example of implementation for the reading of several physicochemical values, the different sensors 1A, 1B, 1C, . . . , are connected to a single light source 2′, for example constituted by a multicolor LED.

As previously indicated, the electronic control circuit 3 is configured to vary the light intensity of the LED(s) depending on the sizes of the physicochemical value(s) measured by the sensor(s) 1A, 1B, 1C, . . . .

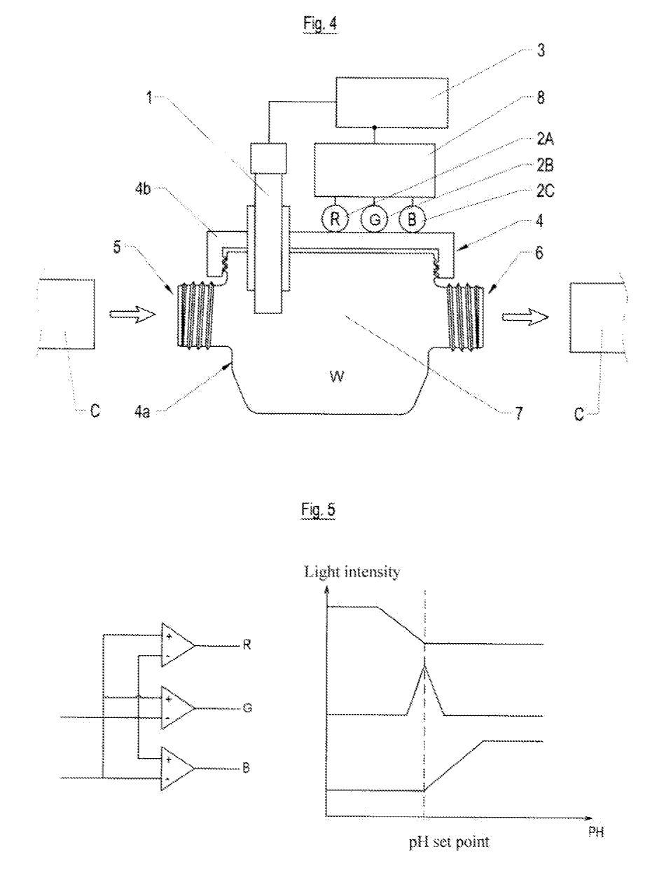

According to the example of implementation illustrated in FIG. 4, the detection and display device includes a probe or sensor 1 capable of measuring the pH of the water W circulating in the housing 4. According to the implementation illustrated in FIG. 3, the electrochemical sensors 1A, 1B, 1C, . . . , are constituted by electrodes of an electrolysis device or electrolyzer, immersed in a flow of water traversing a chamber of electrolytic measurement 7 or cell, and traversed by a continuous electric current of electrolysis.

As illustrated in FIG. 5, for the measurement and display of pH, one attributes, for example:
one LED of green color to this value, when it is close to its set value, i.e. when it is close to 7.2;
one LED of red color when the pH is below this set value; and
one LED of blue color when the pH is above this set value.

Thus, when the pH of the analyzed water drops, the light intensity produced by the red LED increases, whereas the light intensities produced by the green and blue LEDs diminish, so that the cell is illuminated in red, indicating that the pH is below the desired value.

When the pH is close to its set value, the light intensity produced by the green LED increases, whereas the light intensities produced by the red and blue LEDs diminish, so that the cell is illuminated in green, indicating that the pH is ideal.

When the pH rises, the light intensity produced by the blue LED increases, whereas the light intensities produced by the red and green LEDs diminish, so that the cell is illuminated in blue, indicating that the pH is above its desired value.

According to another example of implementation for the measure and display of the redox potential (ORP), one attributes, for example, a LED of green color to this value. Thus, when the measured value deviates from the desired set value, for example equal to 650 mV, the light intensity produced by the green LED increases, so that the cell is illuminated in green.

According to another example of implementation in which the user wishes to monitor simultaneously the pH and the redox potential (ORP), one attributes, for example, a LED of red color to the measurement of the pH and a LED of green color to the measurement of the ORP, so that:
if the pH value deviates from the set value and the ORP value remains close to its set value, only the intensity of the red LED increases and the cell is illuminated in red;
if the ORP value deviates from the set value and the pH value remains close to its set value, only the intensity of the green LED increases and the cell is illuminated in green;
if the pH value and that of the ORP deviate simultaneously from their respective set value, then the light intensity of the two red and green LEDs increases so that the cell is illuminated in yellow.

Thus, the observation of the single resulting color allows monitoring several physicochemical values.

Many swimming-pools are equipped with electrolyzers which produce chlorine by electrolysis of salt water. These devices are generally constituted by electrodes which, in spite of proper treatment, oxidize, which reduces their useful life. Thus, in order to optimize the useful life of an electrolysis cell, it is advisable to maintain the current of electrolysis within a determined range, comprised between a minimum current intensity Imin and a maximum current intensity Imax. Now, the electrolysis current depends on the conductivity of the water which itself depends on the temperature and on the salinity of the water.

Thus, in order to ensure the proper functioning of these electrolysis devices, the user must monitor the intensity of the electrolysis current eI and act, if necessary, on the salinity of the water of the swimming-pool.

According to one example of implementation, specific for monitoring the electrolysis current:
a red LED is attributed to a weak production of electrolysis current;
a blue LED is attributed to a strong production of electrolysis current;
a sensor measures the intensity of the electrolysis current;
the light intensity of the blue LED (Pblue) is modulated according to the formula:

Pblue=(Imax−eI)/(Imax−Imin)×100%
the light intensity of the red LED (Pred) is modulated according to the formula:

Pred=(eI−Imin/(Imax−Imin)×100%

so that:
if the production of electrolysis current eI is too weak, the cell is illuminated in red;
if the production of electrolysis current eI is too high, the cell is illuminated in blue;
if the production of electrolysis current eI is ideal, the cell is illuminated in magenta (the color resulting from the illumination of the blue and red LEDs).

Thus, the reading and the interpretation of information is simple and the user can easily correct the salinity of the water.

Power modulation can take place by varying a control current or by varying a cyclical lighting rate of the corresponding electroluminescent diode. For example, a pulse width of the power supply can be varied.

The cell may also contain a temperature sensor 9 of the flow of water traversing the measurement chamber 7 (FIG. 3). The data emitted by this sensor is then linked to the light power of a LED, for example of green color. Furthermore, in FIG. 3, the reference 10 designates a current sensor. This current sensor 10 allows measuring the intensity of the continuous electric current of electrolysis.

According to an example of implementation in which temperature and water conductivity are monitored simultaneously, the temperature can be displayed by a green LED, and the conductivity of the water can be displayed by red and blue LEDs. When electrolysis is halted, only the temperature sensor is active and only the green LED illuminates so that the cell is illuminated only as a function of the water temperature. When electrolysis is in production, the illumination color of the cell varies, simultaneously as a function of the illumination of the green LED indicating the water temperature, but also as a function of the red and blue LEDS of the conductivity of the water (red, blue or magenta, depending on the production of electrolysis current).

1. Device for colorimetric measurement and signaling of one or several physicochemical values of a liquid medium, comprising:
at least one sensor capable of measuring at least one physicochemical parameter of the medium;
at least one light indicator designed to emit a colored light with a variable color depending on an electrical control signal, the light indicator comprising a plurality of monochrome light sources capable of emitting, each, a light with a specific color, and with variable intensity, the light sources being designed so as to produce said variable color by synthesis of the specific colors of the monochrome light sources;
an electronic control circuit connected to the sensor and configured to convert at least one measurement of the sensor into an electrical input signal of the indicator to cause the emission of a light with a resulting color depending on the measurement of said physicochemical parameter.

2. Device for colorimetric measurement and signaling as per claim 1, in which the control circuit has been adapted to produce a pulse width modulation signal for each monochrome light source, so as to adjust the light intensity.

3. Device for colorimetric measurement and signaling as per claim 1, characterized in that it comprises a plurality of sensors capable of measuring respectively distinct physicochemical parameters of the medium to be analyzed, the control circuit being connected, respectively, to each sensor and being capable of producing a distinct input signal respectively for each of the light sources of the indicator, in response respectively to the measurement of a distinct sensor, in such a manner that the light intensity emitted by each source is a function respectively of the measurement of a sensor.

4. Device for colorimetric measurement and signaling as per claim 1, comprising also a chamber for electrolytic measurement, and in which the sensor features electrodes suitable for being immersed in a flow of water traversing the chamber for electrolytic measurement.

5. Device for colorimetric measurement and signaling as per claim 1, comprising a housing with a hollow body and a cover which delimit a watertight measuring chamber, at least a portion of the housing being made of a transparent or translucent material, the sensor and the light indicator being housed in the housing.

6. Device for colorimetric measurement and signaling as per claim 5, in which the cover of the housing is made of a transparent or translucent material, and in which the light indicator is housed in the cover of the housing.

7. Device for colorimetric measurement and signaling as per claim 5, in which the housing is provided with an inlet opening and an outflow opening intended for branching said device on an outflow pipe of a swimming-pool, so that when the housing is installed on said pipe, the sensor is immersed in a current of water traversing the housing.

8. Device for colorimetric measurement and signaling as per claim 1, comprising a sensor for measuring the intensity of an electric current of electrolysis and a temperature sensor.

9. Device for colorimetric measurement and signaling as per claim 1, in which the light indicator features at least one multicolor electroluminescent diode.

10. Device for colorimetric measurement and signaling as per claim 1, in which the monochrome sources feature electroluminescent diodes (LED) of complementary colors.

11. Method for chronometric measuring and display of physicochemical data in a liquid medium, characterized in that at least one sensor sensitive to at least one physicochemical parameter is immersed in the medium, at least one measurement signal of the sensor is supplied to a control circuit of a light indicator capable of emitting a light of variable color, and a control signal of the control circuit is supplied to the light indicator so as to emit a light the color of which is dependent on the measurement of the sensor, in which a light indicator with a plurality of light sources is used which are capable of each emitting a light of a specific color, and with variable intensity, the monochrome light sources being designed so they produce said variable color by synthesis of the specific colors.

12. Method for chronometric measuring and display as per claim 11, in which a plurality of distinct sensors are used which are each designed to be sensitive to one of the physicochemical parameters of the medium, and an electrical control signal is supplied to each light source respectively as a function of a measurement signal from each sensor, so that each light source of the indicator emits a light with an intensity that is a function of the measurement of the corresponding sensor.

13. Method as per claim 11, in which the liquid medium is water the healthfulness or sanitary condition of which is to be analyzed, and in which the light emitted by a light indicator is used to illuminate the medium.
